(19) United States
(12) Patent Application Publication
(10) Pub. No.: US 2003/0219616 A1
(43) Pub. Date: Nov. 27, 2003

(54) Glass with colorful refraction design

(76) Inventor: Hsu-Fu Cheng, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/152,736

(22) Filed: May 23, 2002

(51) Int. Cl. B32B 1/00

(52) U.S. Cl. 428/542.2

(57) ABSTRACT

A glass with colorful refraction design includes a glass and a decorative paper. The glass has a thick refraction area with a conical surface near the bottom end. The glass is formed with a larger diameter at the top and a smaller diameter at the bottom. The decorative paper is wrapped in the bottom end of the glass. The refraction area is able to refract light, and a colorful pattern on the decorative paper will be refracted onto the conical surface to provide a three-dimensional image.

### FIELD OF THE INVENTION

This invention relates to a glass, and more particularly to one that provides a refraction area having a conical surface at the bottom end of the glass to refract a three-dimensional image on the glass.

### BACKGROUND OF THE INVENTION

Conventional cups on the market are mostly made of glass, ceramic, stainless steel, or plastic. The glass material has better transparent level and is elegant compared with the other materials. Ceramic has better plasticity, which can be made of various shapes with colorful design and provide an artwork feeling. However, both glass and ceramic materials are easy to break, while the stainless steel is more solid compared with the aforesaid two materials, but it lacks an artwork feeling. Plastic material is very close to glass in its transparency and soft skin, which material is strong enough. Since all glasses are made of the same material, how to change to make the glass more attractive is becoming the priority of manufacturers. A renovated glass design, as shown in FIG. 7 is derived, which has a recess B at its bottom end. The recess B is filled with different ornaments C and then sealed with transparent resin. This design makes the glass bottom to show a three-dimensional design, however, this product requires more labor to work on it, and consumers have to watch the design from the top of the glass, and due to the ornaments are sealed in the bottom end randomly, therefore, the effect is not appropriate.

In view of this, the inventor has derived the present invention.

### SUMMARY OF THE INVENTION

It is the primary object of the present invention to provide a glass with colorful refraction design, which provides a vivid pattern of the glass to make it more valuable.

It is another object of the present invention to provide a glass with colorful refraction design, which is more attractive to consumers.

It is a further object of the present invention to provide a glass with colorful refraction design, which is inexpensive in mass production.

### BRIEF DESCRIPTION OF THE DRAWINGS

FIG. 1 is an exploded view of the present invention;

FIG. 2 is a side view of the present invention, partially sectioned;

FIG. 3 is a top view of the present invention;

FIG. 4 is a side view of the present invention;

FIG. 5 is a side view of another embodiment of the present invention;

FIG. 6 is a side view of the present invention applied on a glass of different shape; and

FIG. 7 is a glass of a prior art.

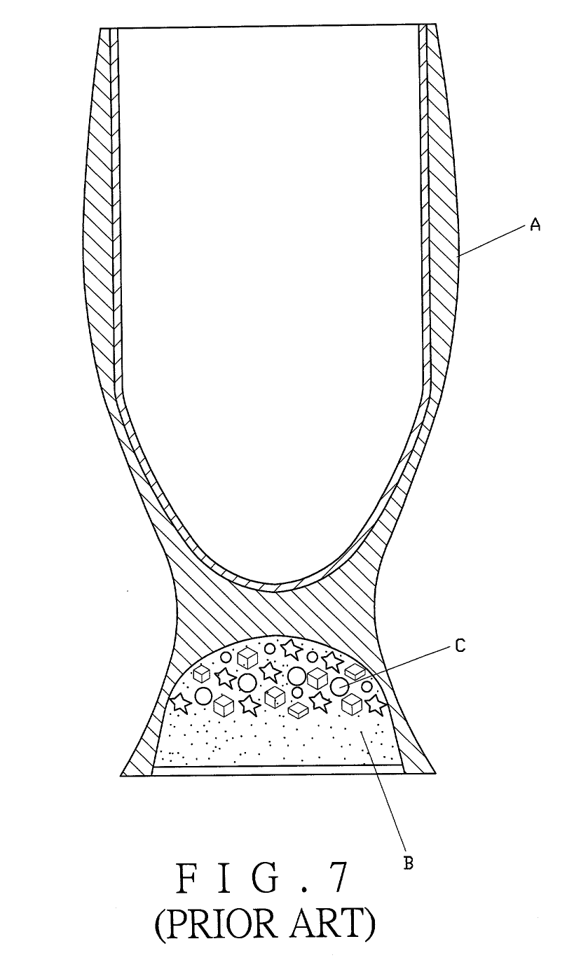

### DETAILED DESCRIPTION OF THE PREFERRED EMBODIMENT

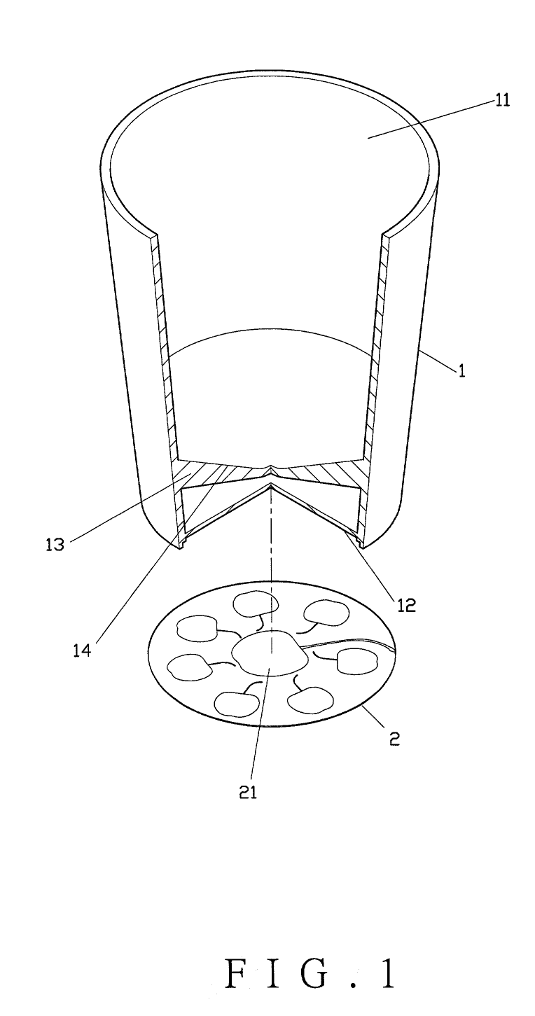

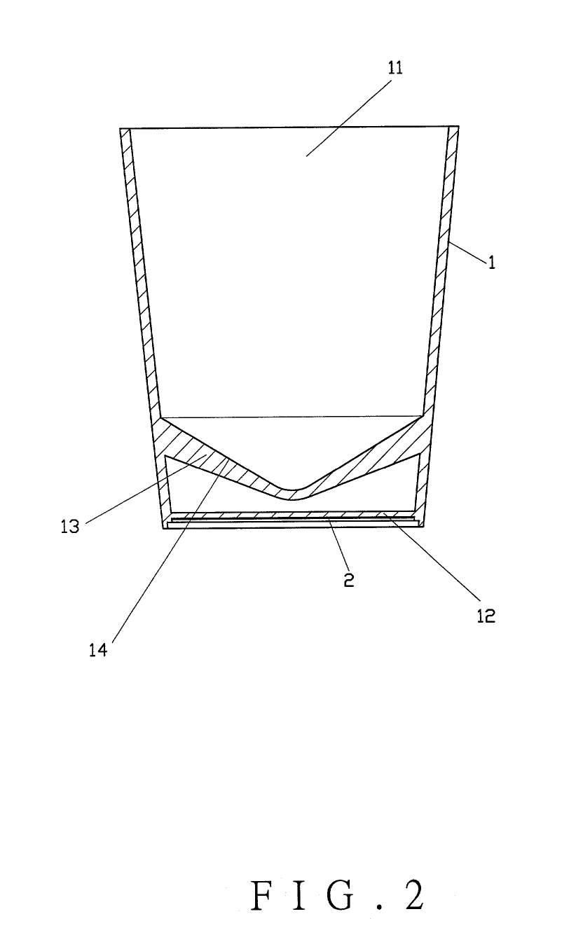

A glass with colorful refraction design of the present invention comprises a glass 1 and a decorative paper 2, as shown in FIGS. 1 and 2.

The glass 1 is made of transparent material with an opening 11 at its top end. The diameter of the opening 11 is larger than that of the bottom end 12. The glass 1 has a thick refraction area 13 near the bottom end 12. The refraction area 13 has a conical surface 14.

The decorative paper 2 is wrapped in the bottom end 12 of the glass 1, and which may be formed by integral injection with the glass 1 or be stuck thereto. The decorative paper 2 is a made of thin paper with printed colorful pattern 21 on the top thereof.

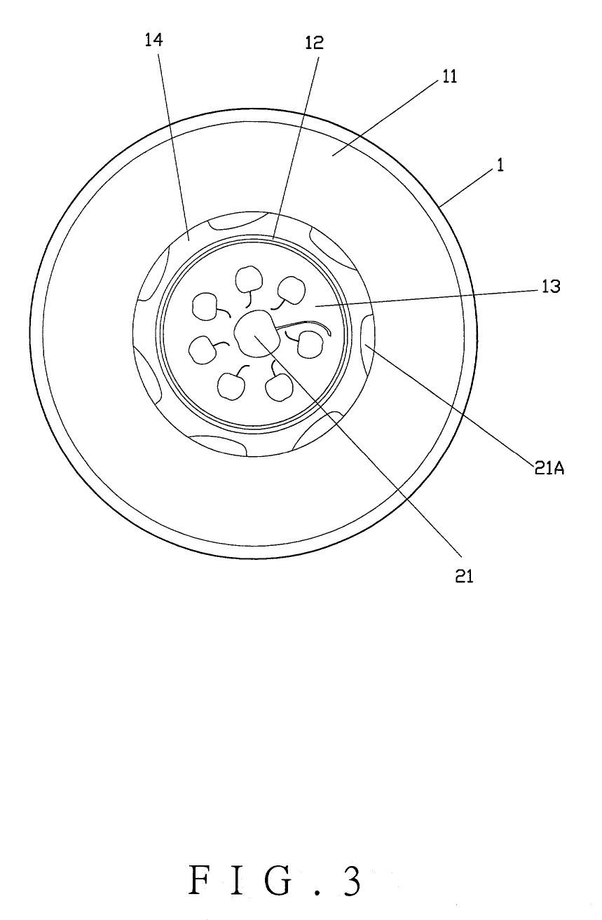

When the decorative paper 2 is placed in the bottom end 12 of the glass 1, a viewer may watch the figure from the opening 11 of the glass 1, as shown in FIG. 3. Due to the opening 11 of the glass 1 has a larger diameter with respect to the diameter of the bottom end 12, the viewer may not only see the colorful pattern 21 on the conical surface 14 but also find a refraction pattern 21A from other area of the glass 1 because of the refraction of light. This provides a layer feeling and causes a three-dimensional figure.

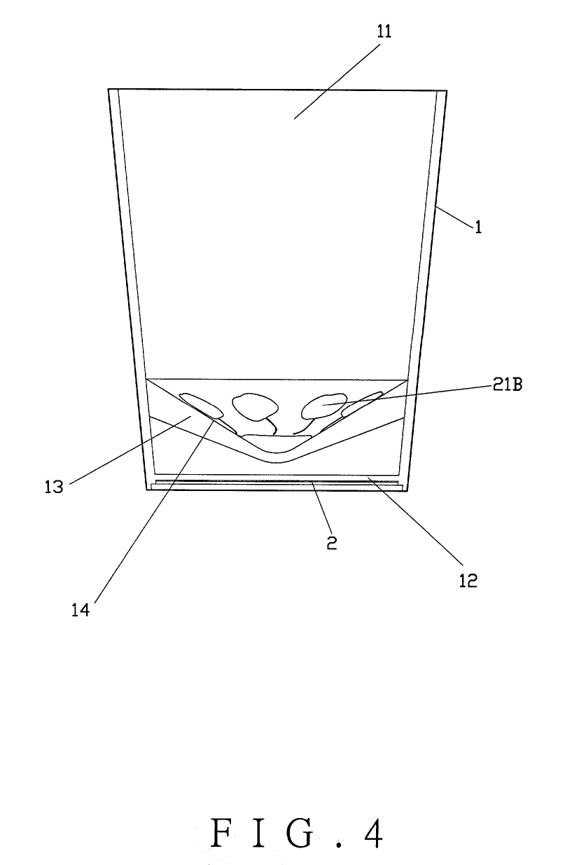

When viewing from outside of the glass, as shown in FIG. 4, the refraction effect of the conical surface 14 makes light not transparent from the conical surface 14 and become a reflection surface, therefore the colorful pattern 21 of the decorative paper 2 will be refracted on the conical surface 14 to form a refraction pattern 21B, this also provides a layer effect. When viewing the glass 1 from different angles, the viewer will get different refraction patterns.

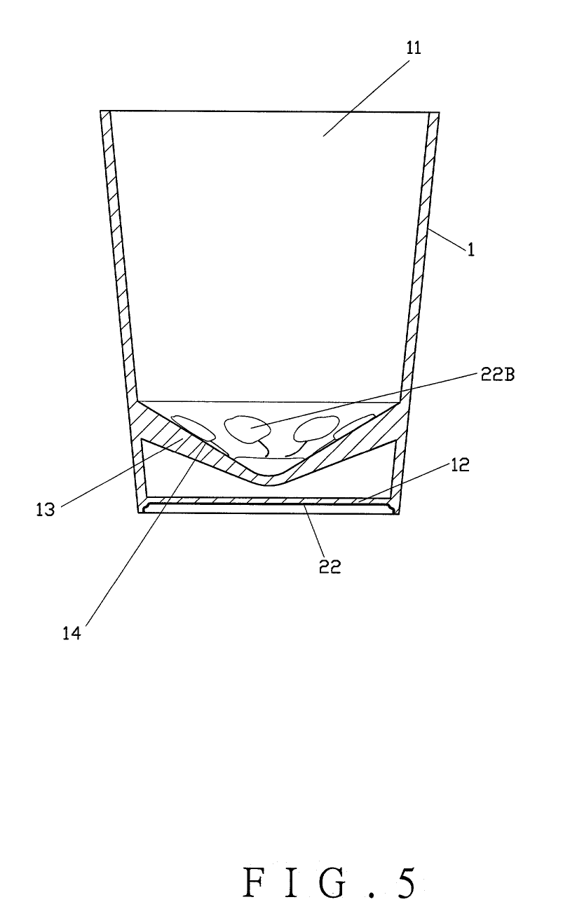

The bottom end 12 of the glass 1 may be printed with a colorful pattern 22, as shown in FIG. 5, the conical surface 14 also provides a refraction effect to form a refraction figure 22B, this saves the procedure of placing the decorative paper 2 in the bottom end 12 of the glass 1. This not only saves time but also provides a more colorful figure.

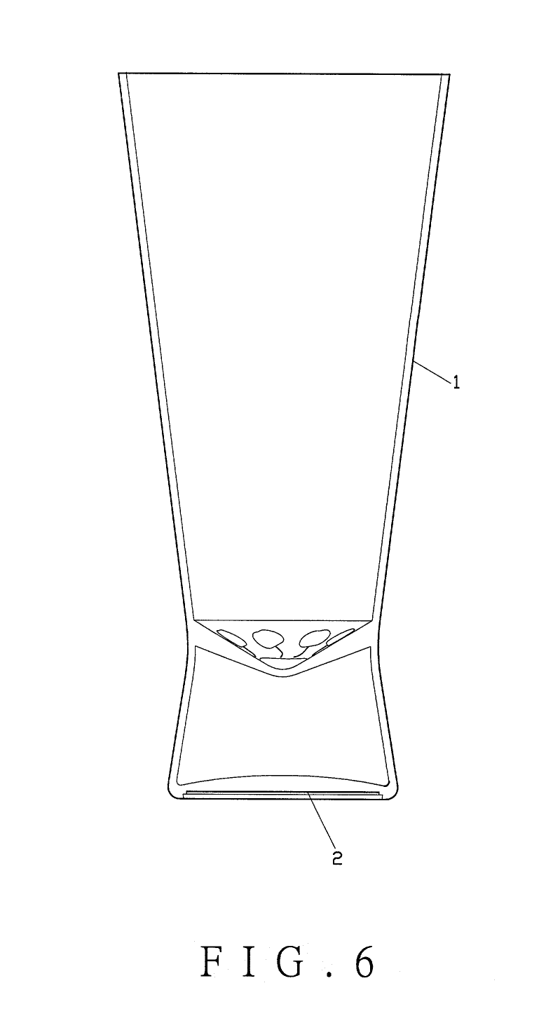

The design is able to be adapted on a glass of different shape, such as FIG. 6.

I claim:

1. A glass with colorful refraction design comprising a glass and a decorative paper, wherein
said glass being made of transparent material having an opening of a larger diameter with respect to that of a bottom end of said glass, said glass having a thick refraction area near said bottom end, said refraction area having a conical surface;
said decorative paper being wrapped in said bottom end of said glass, with various patterns or figures thereon.

2. The glass with colorful refraction design, as recited in claim 1, wherein said bottom end of said glass is printed with various patterns or figures thereon.

3. The glass with colorful refraction design, as recited in claim 1, is applied to any glass of different shape.
